(19) United States
(12) Patent Application Publication
(10) Pub. No.: US 2019/0124970 A1
(43) Pub. Date: May 2, 2019

(54) FOOD PRINTER WITH MOVEMENT COORDINATES

(71) Applicant: BSH HAUSGERAETE GMBH, MUENCHEN (DE)

(72) Inventors: SEBASTIAN ERBE, BRETTEN (DE); UGUR DOGAN GUEL, MUENCHEN (DE); LUCIA SCHUSTER, STUTTGART (DE); ALVARO SUAREZ IRIBARNE, BARCELONA (ES)

(21) Appl. No.: 16/312,462

(22) PCT Filed: Jun. 8, 2017
(86) PCT No.: PCT/EP2017/063970

§ 371 Date: Dec. 21, 2018

(30) Foreign Application Priority Data
Jun. 22, 2016 (DE) 10 2016 211 157.4

(51) Int. Cl. A23P 30/20; A23P 20/25

(52) U.S. Cl. CPC A23P 30/20; B33Y 10/00; A23P 2020/253; A23P 20/25

(57) ABSTRACT

A system for producing a food item includes a plate and a printhead disposed above the plate for extruding an edible printing mass to generate a three-dimensional configuration of printing mass on the plate. A cooking head is disposed above the plate for cooking a three-dimensional configuration of printing mass on the plate. A rotation device rotates the plate and the printhead and/or cooking head relative to one another about an axis of rotation, so as to position the printhead and/or cooking head above different points on the plate located on a circle around the axis of rotation. A radial device varies a radius of the circle. A control unit obtains a recipe for producing a cooked food item and controls the printhead, the cooking head and the radial device in accordance with the recipe to produce the cooked food item.

The invention relates to a system, in particular to a home appliance or household appliance for printing and cooking a food item.

Food printers can be used to create a three-dimensional arrangement of printing mass from an edible printing mass, which can be cooked subsequently to the printing process (e.g. in a separate oven) in order to provide an individualized cooked food item.

The present document relates to the technical object of providing a system for producing an individualized cooked food item, which has a compact layout and which makes possible a printing and cooking process that is efficient in terms of energy used and time expended.

The object is achieved by the subject matter of the independent claim. Advantageous forms of embodiment are defined in particular in the dependent claims, described in the subsequent description or shown in the figures of the enclosed drawing.

In accordance with one aspect of the invention a system for producing a food item is described. The system can also be referred to as a food printer. The system can be embodied in this case as a home appliance, in particular as a household appliance, which can be placed on the work surface of a kitchen and/or can be built into a kitchen cabinet as a built-in unit.

The system comprises a plate, which can be circular in shape for example. The system further comprises a printhead, which is arranged above the plate, which is configured to extrude edible printing mass in order to generate a three-dimensional arrangement of printing mass on the plate. The printhead can obtain the printing mass from one or more cartridges or capsules and extrude it via one or more nozzles. In this case the one or more nozzles can be arranged relatively close to the plate (e.g. such that the distance to a surface on the plate to which the printing mass is to be applied is less than or equal to the diameter of an extruded strand of printing mass). The printing mass can then (e.g. as a result or gravity and/or as a result of the contact pressure from the one or more nozzles) be applied to the plate and form a three-dimensional arrangement of printing mass thereon. Where necessary, different types of printing mass can be extruded on the basis of different nozzles of the printhead. In this way complex food items can be produced.

The system also comprises a cooking head, which is arranged above the plate and which is configured to cook a three-dimensional arrangement of printing mass on the plate. In particular the cooking head can be configured to radiate thermal energy onto an upper side of the plate (and in particular onto at least one part of a three-dimensional arrangement of printing mass), to radiate laser beams onto an upper side of the plate (and in particular onto at least one part of a three-dimensional arrangement of printing mass) and/or to radiate ultrasound waves onto an upper side of the plate (and in particular onto at least one part of a three-dimensional arrangement of printing mass). The use of a cooking head enables (if necessary while the printing process is still going on) an (if necessary localized) printing process to be carried out, in order to produce a cooked food item from a three-dimensional arrangement of printing mass. The provision of a cooking head in combination with a printhead makes it possible to expedite the production process and also to produce complex food items.

Moreover the system comprises rotation means, which are configured to rotate the plate on the one hand and the printhead and/or the cooking head on the other hand relative to one another around an axis of rotation in order to position the printhead and/or the cooking head over different points on the plate. In this case the different points lie in a circle around the axis of rotation. The relative movement between plate on the one hand and printhead and/or cooking head on the other can be brought about by only the plate, only the printhead or both the plate and also the printhead or the cooking head being moved. The rotation means can be configured to bring about a relative movement with a specific (if necessary fixed) speed of rotation.

The system furthermore comprises radial means, which are configured to change a radius of the circle, in particular the radial means are configured to change the radius of the circle on which the points on the plate lie, above which the printhead and/or the cooking head can be positioned by the rotation means. Thus, through the rotation means and the radial means, via the adaptation of polar coordinates, different points on the plate can be moved to, in order to extrude printing mass (with the aid of the printhead) and/or in order to cook printing mass (with the aid of the cooking head).

The system further comprises a control unit, which is configured for establishing a recipe for producing a cooked food item. The recipe can indicate for example the points at which printing mass must be extruded on the plate and/or how the extruded printing mass is to be cooked. The control unit is further configured to activate the printhead, the cooking head and the radial means as a function of the recipe in order to produce the cooked food item.

If necessary the rotation means can be controlled as a function of the recipe. As an alternative the rotation means can bring about a rotational movement with a fixed speed of rotation. The different points on the plate can then be implemented by adaptation in a radial direction. Through a constant rotational movement the process of producing a food item can be expedited.

Furthermore the system typically comprises an (enclosed) housing, which surrounds the plate, the printhead, the cooking head, the rotation means and the radial means.

The system thus uses means for positioning the printhead and/or the cooking head, which are configured to move the cooking head and/or the printhead and/or the plate along one or more polar coordinates. This enables the cooking head and/or the printhead to be positioned efficiently with regard to available space and time. Furthermore a cooked food item can be provided in an efficient manner with regard to space, energy and time.

The radial means can comprise a radial guide rail, which runs in parallel to the plate. In this case the radial guide rail can extend transversely above and/or below the plate. The radial means can also comprise one or more radial actuators, which are configured to move the cooking head and/or the printhead and/or the plate along the radial guide rail. The provision of a radial guide rail enables an efficient movement in terms of space in the radial direction to be made possible.

In one example the radial guide rail is located above the plate. The radial means can then comprise a radial actuator, which is configured to move the printhead along the radial guide rail. In this way the radius of the circle on which printing mass will be applied to the plate can be changed. As an alternative or in addition the radial means can comprise a radial actuator, which is configured to move the cooking head along the radial guide rail. In this way the radius of the circle on which printing mass will be cooked on the plate can be changed. The plate can be fixed in this case such that the plate cannot be moved in the radial direction.

In a further example the radial guide rail can be located below the plate. In this case the radial means can then comprise a radial actuator, which is configured to move the plate along the radial guide rail. The movement of the plate in the radial direction enables the radii of the circumference circles for the printhead and/or the cooking head to be adapted. The printhead and/or the cooking head can if necessary be fixed in this case such that they cannot be moved in the radial direction.

The radial means can comprise at least one longitudinal bar which runs in parallel to and offset from the axis of rotation. For example the one or more longitudinal bars can run next to the plate (e.g. at right angles to a floor or to a base of the system).

Furthermore the radial means can comprise a transverse printhead bar, which runs in parallel to the plate and to which the printhead is attached. Moreover the radial means can comprise a rotation actuator, which is configured to rotate the transverse printhead bar around one of the at least one longitudinal bars, in order to position the printhead at different points above the plate. As an alternative or in addition the radial means can comprise a transverse cooking head bar, which runs in parallel to the plate and to which the cooking head is attached. Moreover the radial means can comprise a rotation actuator, which is configured to rotate the transverse cooking head bar around one of the at least one longitudinal bars, in order to position the cooking head at different points above the plate.

The provision of a longitudinal bar in combination with a transverse bar enables the radius to be adapted via a rotational movement and thus in an efficient manner.

The plate can comprise a central area, which is intended for the generation of the three-dimensional arrangement of printing mass. The central area can be surrounded by an edge area of the plate. For example the plate is circular shaped, wherein printing mass can be applied in an inner area of the circular plate and wherein the inner area is surrounded by an edge. The rotation means can be configured to drive the plate in the edge area, in order to rotate the plate around the axis of rotation. For example the rotation means can comprise a toothed rack for this purpose, which runs in the edge area of the plate. Furthermore the rotation means can comprise an actuator, which is configured to drive a toothed wheel, which engages in the toothed bar. In other words the rotation means can comprise a toothed bar drive.

By driving the plate in an edge area, the central area of the plate can be made accessible from below (e.g. for a cooking process). In particular the system can comprise a cooking unit, which is configured to heat up the plate from below (e.g. by means of induction). The control unit can then be configured to activate the plate as a function of a recipe. This enables the cooking process of a food to be improved. The provision of such a cooking unit for provision of bottom heat is especially advantageous in conjunction with a plate, which is driven in an edge area of the plate. This enables efficient heating-up of the plate in its central area to be made possible.

As an alternative or in addition to a drive in the edge area, the plate can have a shaft on which the plate is rotatably supported. The rotation means can be configured to drive the shaft (directly) in order to turn the plate. This enables a rotational movement to be brought about in an efficient manner.

The system can comprise spacing means, which are configured to change a transverse distance of the printhead and/or of the cooking head perpendicular to the plate. The spacing means can be configured to change a height of the printhead and/or the cooking head and/or the plate. The control unit can be configured to activate the spacing means as function of the recipe. The adaptation of the distance between printhead or cooking head and plate enables the printing process or the cooking process to be improved.

The control unit can be configured simultaneously to activate the printhead in order to extrude printing mass at a first point on the plate and to activate the cooking head in order to cook printing mass at a second point on the plate. The provision of a movable printhead and a movable cooking head enables complex food items to be created.

It should be noted that any aspects of the system described in this document can be combined with one another in diverse ways; in particular the features of the claims can be combined with one another in diverse ways.

The invention will be described in greater detail below of the basis of exemplary embodiments presented in the enclosed drawing. In the figures:

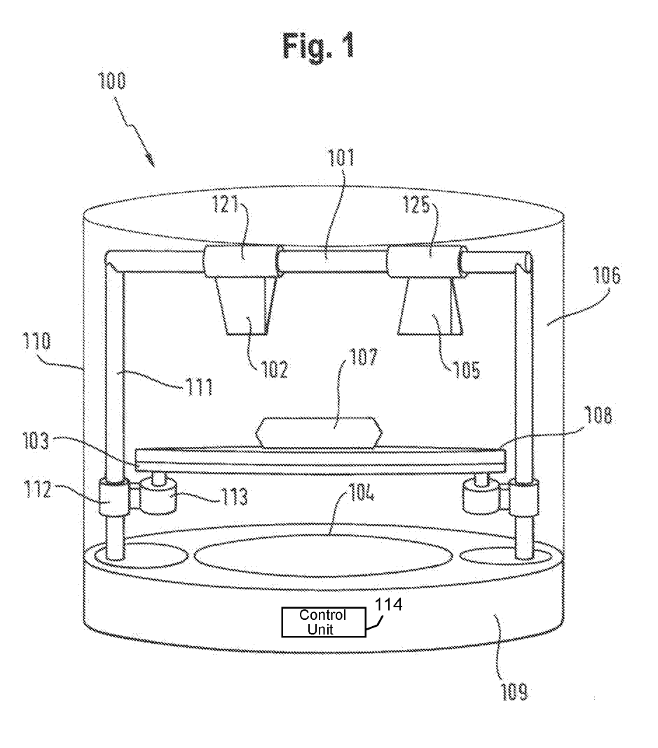

FIG. 1 shows a first example of a system for producing a food item;

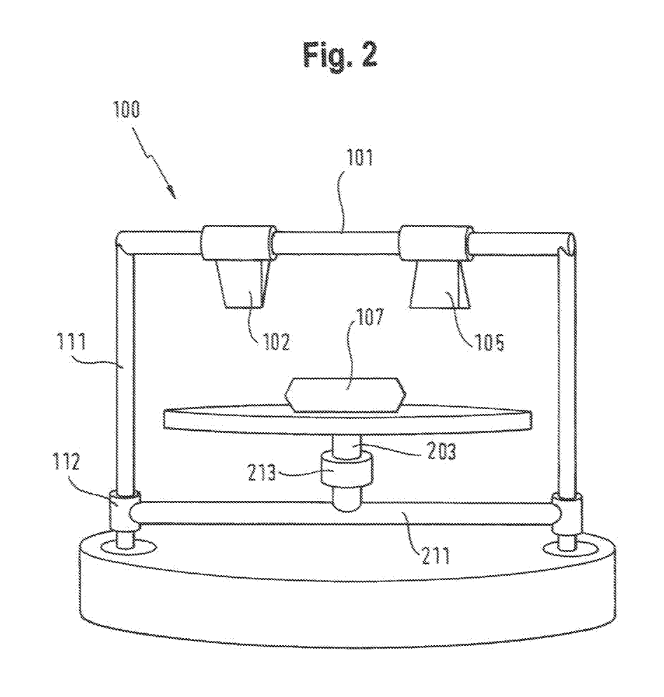

FIG. 2 shows a second example of a system for producing a food item;

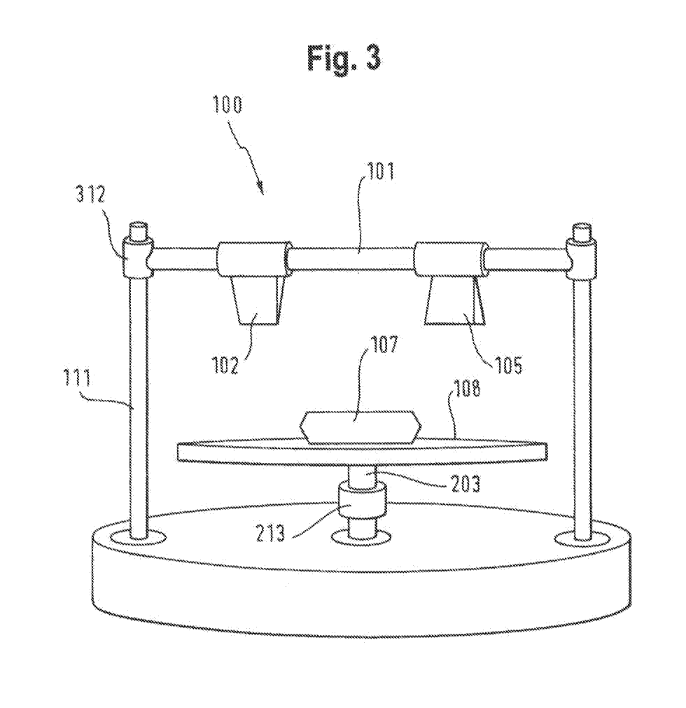

FIG. 3 shows a third example of a system for producing a food item;

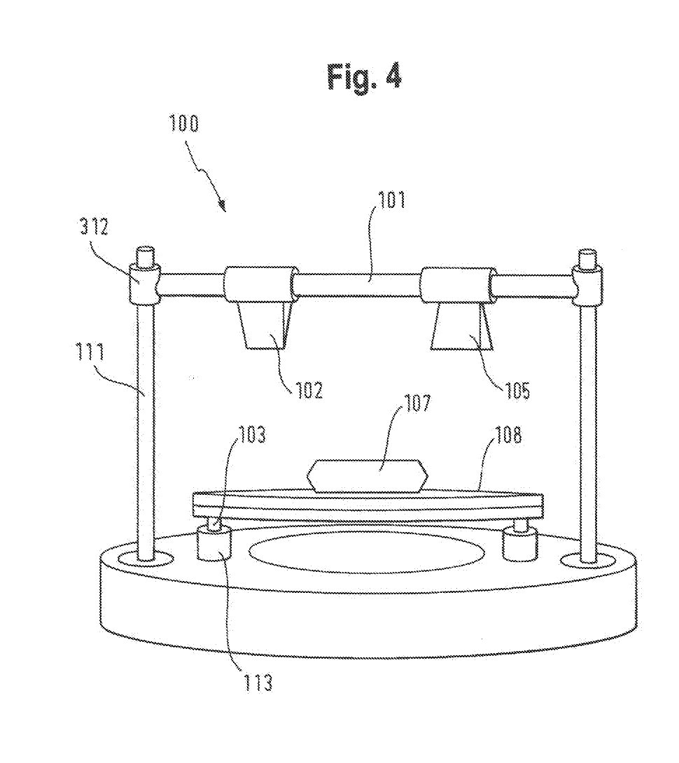

FIG. 4 shows a fourth example of a system for producing a food item;

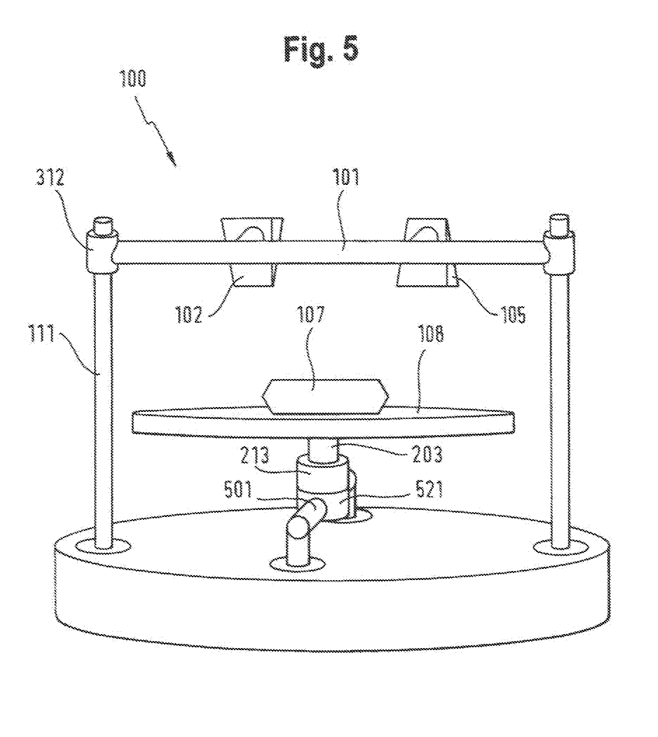

FIG. 5 shows a fifth example of a system for producing a food item;

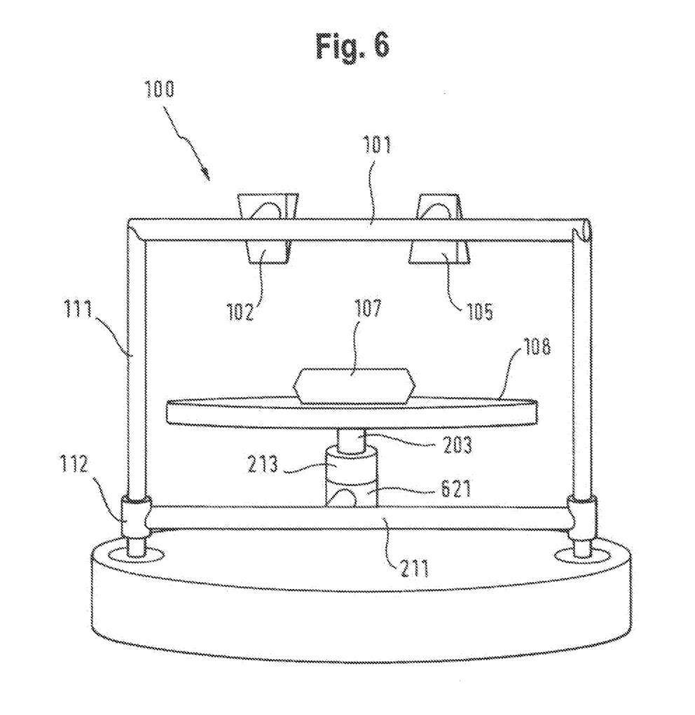

FIG. 6 shows a sixth example of a system for producing a food item;

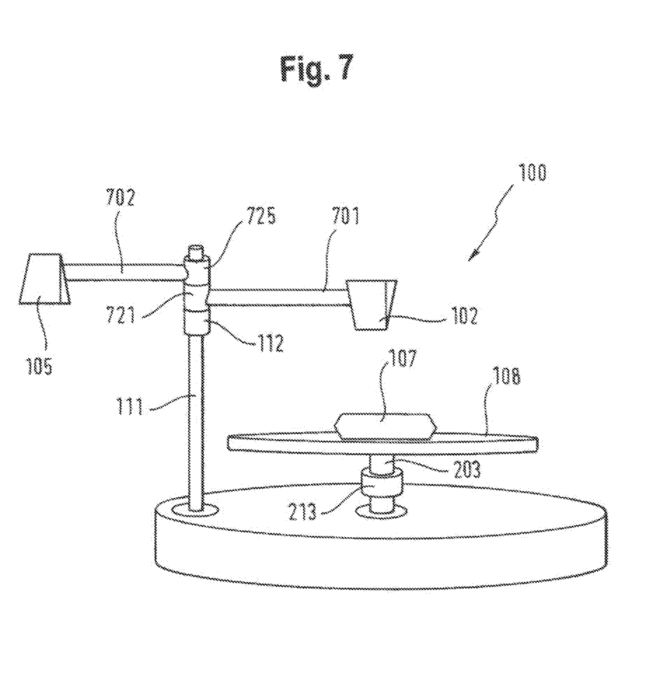

FIG. 7 shows a seventh example of a system for producing a food item;

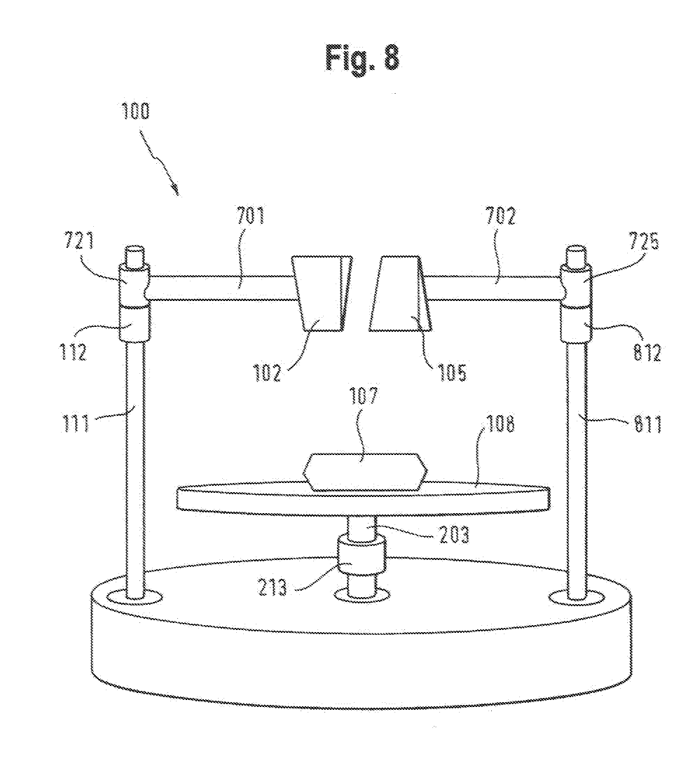

FIG. 8 shows an eighth example of a system for producing a food item; and

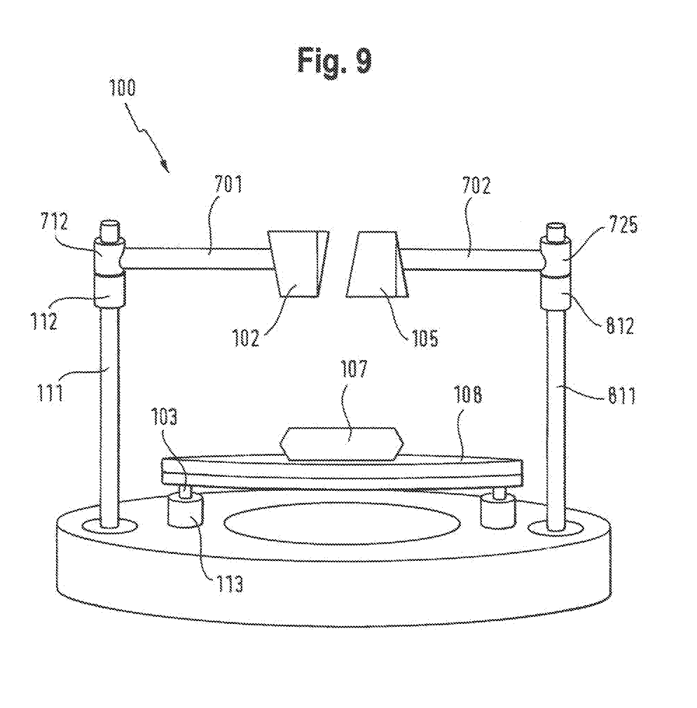

FIG. 9 shows a ninth example of a system for producing a food item;

As stated at the outset, the present document is concerned with the efficient production of a food item in terms of time, space and energy by means of a food printer. In this context FIG. 1 shows a first example of a system 100 for producing a food item 107 (i.e. a food printer). The system 100 has a housing 110, which encloses an inner space 106 and which stands on a base 109. The base 109 can comprise a power supply and/or a control unit (e.g. with a processor) for example. The system 100 can be embodied as a home appliance, in particular as a household appliance, which can be placed with its base 109 on the work surface of a kitchen.

The system 100 comprises a printhead 102, which is configured to extrude edible printing mass onto a plate 108. A three-dimensional arrangement of printing mass can be created by the printhead 102 on the plate 108. Furthermore the system 100 comprises a cooking head 105, which is configured to cook the three-dimensional arrangement of printing mass on the plate 108. For this purpose the cooking head 105 can have a radiant heat source and/or a laser for example. Thus the cooking head 105 can be configured to cook the three-dimensional arrangement of printing mass from above. As an alternative or in addition the system 100 can have a cooking unit 104, which is configured to cook the three-dimensional arrangement of printing mass from below for example. The cooking unit 104 can be configured to heat up the plate 108 via electromagnetic induction.

The system 100 uses polar movement coordinates in order to position the printhead 102 and/or the cooking head 105 over different points on the front side of the plate 108. For this purpose the system 100 from FIG. 1 comprises rotation means 103, 113 in order to rotate the plate 108 around an axis of rotation of the plate 108, wherein the axis or rotation runs perpendicular to the plate 108. Through the rotation means 103, 113 the printhead 102 and/or the cooking head 105 can be moved on a circular path above the front side of the plate 108. In the example shown in FIG. 1 the rotation means 103, 113 are arranged eccentrically in relation to the axis of rotation. This has the advantage that the cooking unit 104 can be taken relatively close to the underside of the plate 108, in order to heat-up the plate 108 for the cooking process. The rotation means 103, 113 comprise a drive element 103 (e.g. a toothed wheel), which is driven by a motor 113. For example a driven toothed wheel can engage into a circumferential toothed rail or toothed bar on the underside of the plate 108, in order to rotate the plate 108.

The printhead 102 and/or the cooking head 105 can be moved using radial means 101, 121, 125 in parallel to the front side of the plate 108, in order to change the radius of the circular path. In the example shown in FIG. 1 the radial means 101, 121 comprise a radial guide rail 101, which runs in parallel to the front side of the plate 108. The printhead 102 can be moved using a printhead actuator 121 along the radial guide rail 101 in order to move the printhead 102 towards the axis of rotation of the plate 108 or away from the axis of rotation of the plate 108. In a similar way the cooking head 105 can be moved using a cooking head actuator 125 along the radial guide rail 101, in order to move the cooking head 106 towards the axis of rotation of the plate 108 or away from the axis of rotation of the plate 108.

Thus, through the combination of the rotation means 103, 113 and the radial means 101, 121, 125, the printhead 102 and/or the cooking head 105 can be positioned over any given points on the front side of the plate 108. The use of movement means, which make movement along polar coordinates possible, enables the different points on the front side of the plate 108 to be moved to efficiently in terms of space and time.

The system 100 shown in FIG. 1 also has spacing means 111, 112, which are configured to change the distance between the printhead 102 and/or the cooking head 105. In the example shown in FIG. 2 the spacing means 111, 112 comprise two spacing guide rails 111 (also referred to in this document as longitudinal bars), which run perpendicular to the base 109 and/or the plate 108. The plate 108 is connected via the rotation means 103, 113 and via a movement mechanism 112 (e.g. via one or more driven toothed wheels) to the spacing guide rails 111 and in this way can be moved upwards or downwards, in order to reduce or to enlarge the distance between the printhead 102 and/or the cooking head 105.

The rotation means, the radial means and/or the spacing means can be controlled by the control unit (not shown) of the system 100, in order to drive the printhead 102 and/or the cooking head 105 (typically as a function of a recipe for a food item 107 to be produced) to different positions, in order to extrude printing mass and/or to cook the printing mass on the plate 108.

FIG. 2 shows a system 100 for producing a food item 107, in which the rotation means 203, 213 are connected via a transverse bar 211 to the movement mechanism 112. The transverse bar 211 can be driven upwards or downwards by the movement mechanism 112 along the spacing guide rails 111, in order to change the distance between the plate 108 and the printhead 102 and/or the cooking head 105.

As shown by way of example in FIG. 2, the rotation means 203, 213 can comprise a drive shaft 203, which runs along the axis of rotation of the plate 108 and which is driven by the motor 213, in order to turn the plate 108.

FIG. 3 shows an example of a system 100 in which the spacing means 111, 312 are designed such that the radial guide rails 101 are driven upwards or downwards via a movement mechanism 312 along the spacing guide rails 111 in order to change the distance between the plate 108 and the printhead 102 and/or the cooking head 105.

FIG. 4 shows an example of a system 100, which combines the rotation means 103, 113 from the system 100 from FIG. 1 with the spacing means 111, 312 from FIG. 3.

FIG. 5 shows an example of a system 100 in which the printhead 102 and/or the cooking head 105 have a fixed connection to the rail 101. The movement in the radial direction is carried out by a radial guide rail 501, which runs in parallel to the base 109 and which is connected to the base 109. The plate 108 is connected via an actuator 521 to the radial guide rail 501 and can be moved in this way along the radial guide rail 501, in order to position different points on the front side of the plate 108 below the printhead 102 and/or below the cooking head 105. The radial means thus comprise the radial guide rail 501 and the actuator 521.

In the example shown in FIG. 6 the radial means comprise the transverse bar 211, which is embodied as a radial guide rail, in order to move the plate 108 by means of the actuator 621 in the radial direction. Furthermore the radial guide 211 can be driven upwards or downwards via the movement mechanism 112 along the spacing guide rails 111 in order to change the distance between the plate 108 and the printhead 102 and/or the cooking head 105.

The system 100 shown in FIG. 7 comprises radial means 701, 721 with which the printhead 102 can be rotated around the spacing guide rail 111, and/or radial means 702, 705 with which the cooking head 105 can be rotated around the spacing guide rail 111. The radial means 701, 721 or 702, 725 comprise a transverse bar 701, 702 in each case, to which the printhead 102 or the cooking head 105 is attached. The respective transverse bar 701, 702 can be rotated around the spacing guide rail 111 by means of the actuators 721, 725. Thus, by rotational movements of the radial means 701, 721 or 702, 725 and the rotation means 203, 213, any given points on the front side of the plate 108 can be moved to (without using translational movements). This can be advantageous in particular in relation to the cabling of the actuators 721, 725 required and in relation to the space required.

FIG. 8 shows an example in which the radial means 701, 721 for the printhead 102 and the radial means 702, 725 for the cooking head 105 are arranged on different spacing guide rails 111, 811. In this way the freedom of movement for the printhead 102 and for the cooking head 105 can be increased. In this case the distance between the cooking head 105 and the plate 108 can be changed via a movement mechanism 812.

FIG. 9 shows an example of a system 100 that combines the radial means 701, 721 or 702, 725 from FIG. 8 with the rotation means 103, 113 for rotating the plate 108 from FIG. 1. In this way the use of heating below the floor of the plate can be made possible.

In this document a system 100 is described that, by moving a printhead 102 and a cooking head 105 along polar coordinates or along cylinder coordinates, makes it possible to produce a food item 107 efficiently in terms of space and time. In particular the printing process and the cooking process can be integrated into a single system 100 in this way, which makes possible the automatic production of ready-cooked food items 107. The rotation means described in this document enable the plate 108 to be continuously rotated if necessary, whereby the printing process and/or the cooking process can be expedited.

The present invention is not restricted to the exemplary embodiments shown. It should be noted in particular that the description and the figures are only intended to illustrate the principle of the proposed system.

1-15. (canceled)

16. A system for producing a food item, the system comprising:
a plate;
a printhead disposed above said plate and configured to extrude an edible printing mass for generating a three-dimensional configuration of the printing mass on said plate;
a cooking head disposed above said plate and configured to cook the three-dimensional configuration of the printing mass on said plate;
a rotation device configured to rotate said plate and at least one of said printhead or said cooking head relative to one another around an axis of rotation for positioning at least one of said printhead or said cooking head above different points on said plate, said different points lying on a circle around the axis of rotation;
a radial device, configured to change a radius of the circle;
a spacing device configured to change a transverse distance of at least one of said printhead or said cooking head perpendicular to said plate; and
a control unit configured:
to establish a recipe for a production of a cooked food item;
to activate said printhead, said cooking head and said radial device as a function of the recipe for producing the cooked food item,
to simultaneously activate said printhead for extruding a printing mass at a first point on said plate and activate said cooking head for cooking a printing mass at a second point on said plate, and
to activate said spacing device as a function of the recipe.

17. The system according to claim 16, wherein said radial device includes:
a radial guide rail extending parallel to said plate; and
at least one radial actuator configured to move at least one of said printhead and said cooking head or said plate along said radial guide rail.

18. The system according to claim 17, wherein:
said radial guide rail is disposed above said plate and extends transversely above said plate;
said at least one radial actuator of said radial device includes a radial actuator configured to move said printhead along said radial guide rail; and
said at least one radial actuator of said radial device includes a radial actuator configured to move said cooking head along said radial guide rail.

19. The system according to claim 17, wherein:
said radial guide rail is disposed below said plate; and
said at least one radial actuator of said radial device includes a radial actuator configured to move said plate along said radial guide rail.

20. The system according to claim 16, wherein said radial device includes:
at least one longitudinal bar extending parallel to and offset relative to the axis of rotation; and
at least one of:
a printhead transverse bar extending parallel to said plate, said printhead being attached to said printhead transverse bar, and a rotation actuator configured to rotate said printhead transverse bar around said at least one longitudinal bar for positioning said printhead at different positions above said plate, or
a cooking head transverse bar extending parallel to said plate, said cooking head being attached to said cooking head transverse bar, and a rotation actuator configured to rotate said cooking head transverse bar around said at least one longitudinal bar for positioning said cooking head at different positions above said plate.

21. The system according to claim 16, wherein:
said plate includes a central area intended for generating the three-dimensional configuration of the printing mass;
said central area is surrounded by an edge area of said plate; and
said rotation device is configured to drive said plate in said edge area for rotating said plate around the axis of rotation.

22. The system according to claim 21, wherein said rotation device includes:
a toothed bar extending in said edge area of said plate;
a toothed wheel engaging into said toothed bar; and
an actuator configured to drive said toothed wheel.

23. The system according to claim 16, wherein:
said plate has a shaft on which said plate is rotatably supported; and
said rotation device is configured to drive said shaft to turn said plate.

24. The system according to claim 16, wherein said cooking head is configured:
to radiate thermal energy onto an upper side of said plate;
to radiate laser beams onto said upper side of said plate; and
to radiate ultrasound waves onto said upper side of said plate.

25. The system according to claim 16, wherein said spacing device is configured to change a height of at least one of said printhead, said cooking head or said plate.

26. The system according to claim 16, which further comprises:
a cooking unit configured to heat said plate from below;
said control unit being configured to activate said cooking unit as a function of the recipe.

27. The system according to claim 16, which further comprises a housing enclosing said plate, said printhead, said cooking head, said rotation device and said radial device.

28. The system according to claim 16, wherein the system is a home appliance or a household appliance.
